(19) United States
(12) Patent Application Publication
(10) Pub. No.: US 2012/0331423 A1
(43) Pub. Date: Dec. 27, 2012

(54) METHOD FOR NAVIGATING A STRUCTURE OF DATA USING A GRAPHICAL USER INTERFACE HAVING A LOOPED HISTORY CHAIN

(75) Inventor: Danny Naoshi Kumamoto, Garden Grove, CA (US)

(73) Assignee: KONICA MINOLTA LABORATORY U.S.A., INC., San Mateo, CA (US)

(21) Appl. No.: 13/167,960

(22) Filed: Jun. 24, 2011

(51) Int. Cl. G06F 3/048

(52) U.S. Cl. 715/853

(57) ABSTRACT

An improved navigation method implemented as a graphical user interface (GUI). The GUI has navigation tools to allow a user to navigate to different locations of a structure of data. The GUI stores a history chain containing a sequence of nodes including a first node and a last node, each node represents a location the user has previously navigated to. The GUI moves backward or forward along the history chain in response to a back or forward command from the user. When a current node position in the history chain is the first (or last) node and a back (or forward) command is received, the GUI moves to the last (or first) node of the history chain, thereby forming a looped history chain.

### BACKGROUND OF THE INVENTION

1. Field of the Invention

This invention relates to a method for navigating a structure of data using graphical user interface (GUI), and in particular, it relates to such a method where the GUI has a history chain.

2. Description of Related Art

In the environment of a computer, data is typically organized in complex hierarchical structures. For example, files in a storage medium are typically organized in multiple levels of folders forming a tree structure. Graphical user interface (GUI) displays are used to provide user access to such data, and such GUIs typically have navigation tools to allow the user to easily navigate to desired locations of the structure of data. For example, a Windows Explorer™ window in the Windows operating system (Vista™ and later) provides a navigation pane that displays the folder tree structure, and allows the user to directly go to any folder by clicking on the desired folder icon in the navigation pane. When the content of a folder is displayed in the main pane of Windows Explorer™, the user can access the files within that folder, or navigate to a sub-folder of the folder.

Windows Explorer™ also provides a navigation history chain that stores a history of the locations previously navigated to. For example, assume the user navigated to folders A, B, C and D in that order. While in folder D, the user may use a “back” command (e.g. a back arrow icon, alt-left arrow keys, etc.) to go back one folder along the history chain to folder C. While in folder C, the user may use a “back” or “forward” command to go back or forward one folder to folder B or D; etc. FIG. 1(a) schematically illustrates an exemplary folder tree structure having folders F1, F2, F11, F12, etc. Letters A, B, C and D indicate the folders previously navigated to.

FIG. 1(b) schematically illustrates a history chain 10, with nodes A, B, C and D forming a one-dimensional chain, each node representing a folder previously navigated to. The double arrows between nodes indicate that the user can go back or forward along the history chain. It is noted that the folders corresponding to nodes A, B, C, D, etc. can be any folders in the folder tree structure shown in FIG. 1(a), and do not have to have any particular logical relationship, because the navigation pane allows the user to go directly to any folder including ones located on completely different branches of the folder tree. Of course, the history chain can follow a branch along the folder tree, such as F1, F13, F131, F1311, if that is how the user navigated the tree structure.

FIGS. 2(a) and 2(b) illustrate an exemplary Windows Explorer™ GUI 20 that has “back” and “forward” button icons 21, 22 used to move along the history chain. The GUI window 20 has a navigation pane 23, and a main pane 24 that displays the content of the current folder.

Similar navigation tools and navigation history chains are provided in many software programs. For example, Adobe™ Reader™ provides a page navigation pane that allows the user to go directly to any desired page of the PDF document by clicking on a thumbnail image of the page. It also provides a bookmark navigation pane that allows the user to go directly to a desired bookmark location such as the start of a chapter or section. A history chain is stored for locations previously navigated to, and the sequence of these locations is unrelated to the actual position of the locations in the document. “Back” and “forward” commands are provided to move back and forward in the history chain. The “back” and “forward” commands are different from the “next page” and “previous page” commands because the latter only move along the page sequence of the document.

Display methods have been described for displaying a group of objects, such as thumbnail images in a digital camera, where when the display scrolls through the objects, and reaches the last (or first) object, the display will loop back to the first (or last) object. Such methods are described in, for example, US20110032407 and US20110025711.

### SUMMARY

The present invention is directed to an improved navigation method and related graphical user interface display that substantially obviates one or more of the problems due to limitations and disadvantages of the related art.

An object of the present invention is to improve the ease of navigation through large amounts of data or data organized in a complex hierarchy.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a computer for navigating a structure of data having a plurality of locations, which includes: (a) receiving a navigation command from a user indicating a selected location in the structure of data; (b) displaying a content of the selected location; (c) storing a representation of the selected locations as a node in a history chain; (d) repeating steps (a) to (c) to build the history chain, the history chain having a sequence of nodes including a first node and a last node, each node representing a selected location received in step (a); (e) receiving a back command or a forward command from the user; (f) moving a current node position in the history chain backward or forward by one node in response to receiving the back command or forward command, respectively, wherein when the current node position is the first node, the current node position is moved to the last node in response to receiving the back command, and when the current node position is the last node, the current location is moved to the first node in response to receiving the forward command; (g) displaying a content of the location represented by the current node position in the history chain; and (h) repeating steps (e) to (g).

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIGS. 1(a) and 1(b) schematically illustrates an exemplary prior art folder tree structure and a navigation history chain.

FIGS. 2(a) and 2(b) illustrate examples of a prior art GUI display for navigating in a folder tree structure with navigation history functions.

FIG. 3 schematically illustrates a GUI display method providing a looped navigation history chain according to an embodiment of the present invention.

FIG. 4 schematically illustrates a method implementing the GUI display with looped history chain according to the embodiment of the present invention.

### DETAILED DESCRIPTION OF PREFERRED EMBODIMENTS

The navigation methods and GUI displays described below can be implemented in a computer or other data processing system which includes a processor and a memory or storage device. The data processing system carries out the method by the processor executing computer programs stored in the memory or storage device. In one aspect, the invention is embodied in a data processing system. In another aspect, the invention is computer program product embodied in computer usable non-transitory medium having a computer readable program code embedded therein for controlling a data processing apparatus. In another aspect, the invention is a method carried out by a data processing system. Here, the term GUI may refer to the hardware and program which collectively implement a graphical user interface. The term GUI may also refer to the graphical display itself, depending on the context.

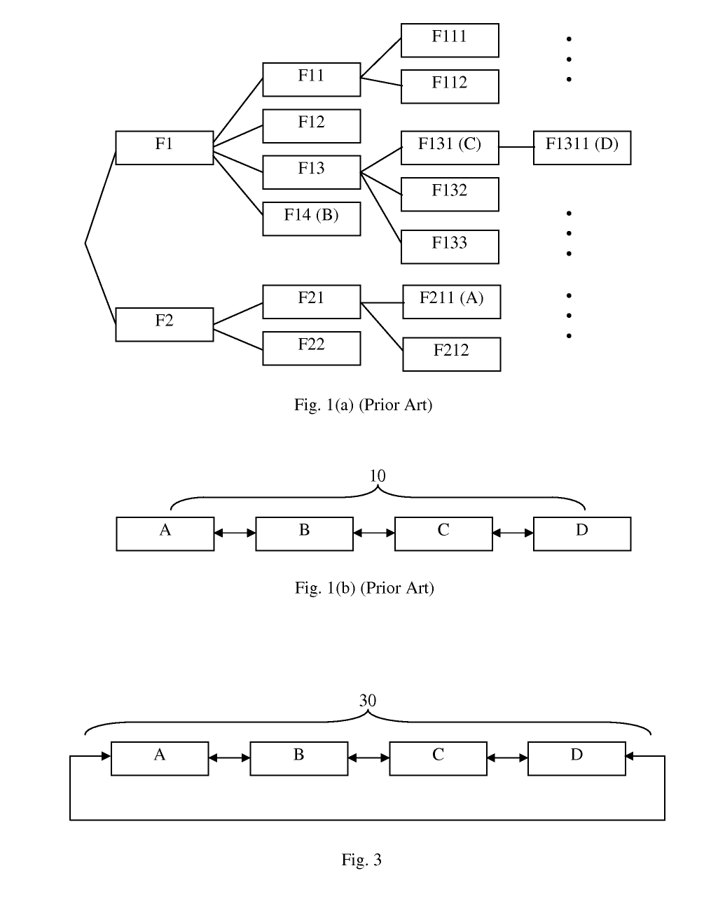

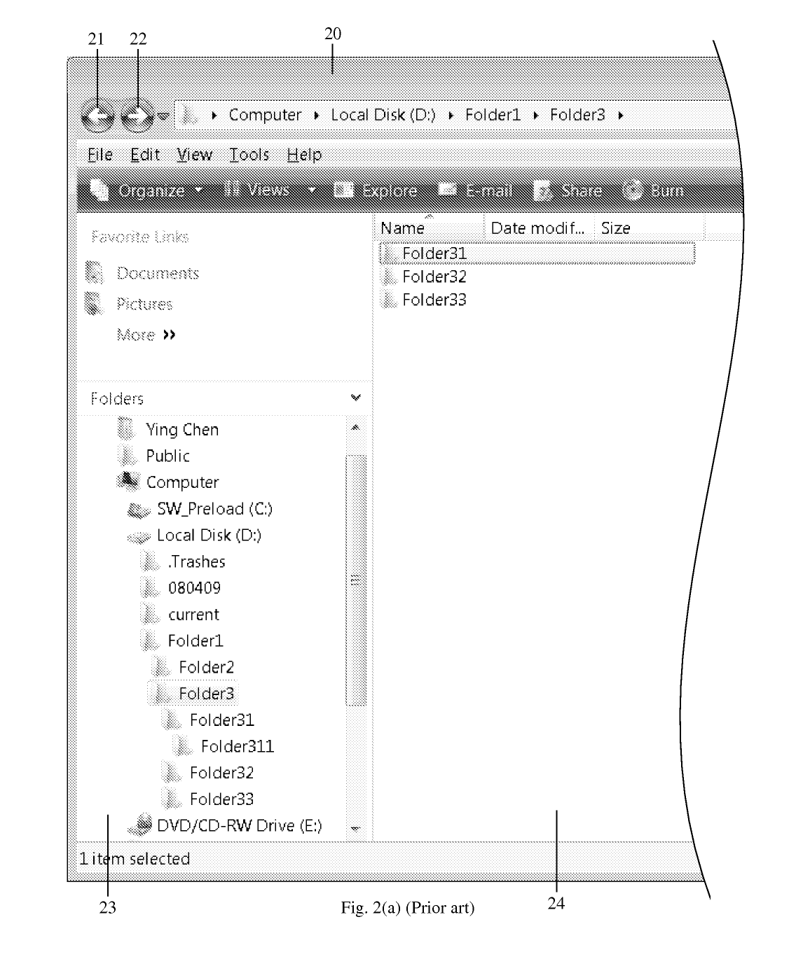

As shown in FIG. 1(b), in a conventional navigation system with a navigation history chain 10, the user can move backward and forward along the history chain (which comprises nodes A, B, C and D in this example). But if the user reached the last node (or the first node) of the history chain, node D (or A) in this example, and the user issues another forward (or back) command, the command is ignored and the location in the history chain is not changed. In fact, in Windows Explorer™, the non-effective forward or back arrow icons are grayed out in such a situation (see FIG. 2(b), arrow 22).

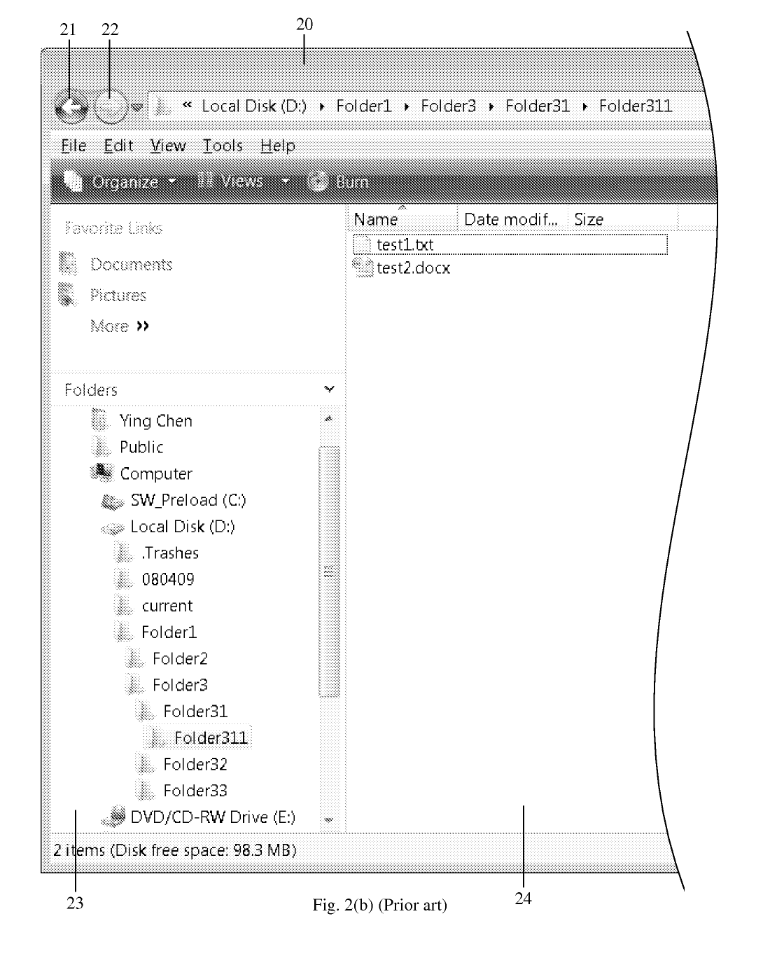

FIG. 3 schematically illustrates a navigation method according to an embodiment of the present invention. A conventional GUI is improved to implement the method of FIG. 3. The navigation method may be implemented for navigating any structure of data that includes a plurality of locations each containing a content. The improved GUI generally may have a similar appearance as a conventional GUI (e.g. Windows Explorer™). For example, it may provide a navigation pane to allow the user to easily navigate the structure of data, and provide a main pane to display the content of the current location, as shown in FIGS. 2(b) and 2(b). Like the conventional GUI, the improved GUI also provides a navigation history chain 30 that stores a history of the locations previously navigated to. The history chain contains a sequence of nodes (from the first node to the last node) each representing a location previously navigated to. FIG. 3 shows the history chain 30 comprising nodes A, B, C and D. The user can use a “back” or “forward” command of the GUI to go back or forward one step along the history chain 30, as indicated by the double arrows between neighboring nodes in FIG. 3.

When the current node position in the history chain 30 is the first node, node A in this example (e.g., the user may have used the back command to move back to the first node in the history chain), and the user issues another back command, the GUI will move to the last node of the history chain, node D in this example. This is indicated in FIG. 3 by the arrow pointing from node A to node D. Likewise, when the current node position in the history chain is the last node, node D in this example, and the user issues another forward command, the GUI will move to the first node of the history chain, node A in this example. This is indicated in FIG. 3 by the arrow pointing from node D to node A. In this manner, the user can move along the history chain 30 as a loop, and the user's back or forward command are never ignored. It is noted that the nodes in the history chain 30 can correspond to any location in the structure of data, depending on how the user has navigated the structure of data, and they can be locations located at different levels within a tree structure. It should be further noted that the construction of the history chain does not change the logical relations of the respective locations in the structure of data, nor does it duplicate any content of the locations.

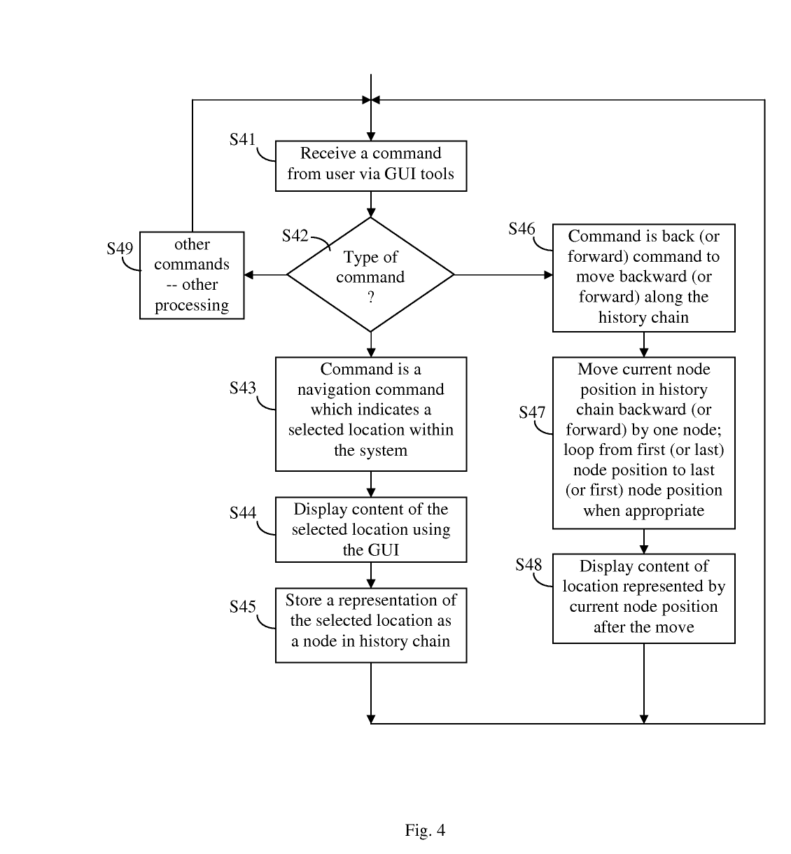

FIG. 4 illustrates a flow of the navigation method of the GUI according to the embodiment of the present invention. When the GUI receives a command from a user (step S41), e.g. via a GUI tool, the GUI determines the nature of the command (step S42). If the command is a navigation command indicating a selected location within the structure of data (step S43), it displays the content of the selected location (step S44). The GUI stores a representation of the selected location received in step S41 as a node in a history chain (step S45). Steps S41 to S43 may be the same as the corresponding steps in the conventional GUI. Steps S43 to S45 are repeated when the GUI receives additional navigation commands as the user navigates through the system. A history chain is built up this way, and contains a sequence of nodes each representing a selected location received in step S41.

If the command received in step S41 is a back or forward command to move backward or forward by one node along the history chain (step S46), the GUI moves the current node position in the history chain backward or forward by one node (step S47). When moving along the history chain, if the current node position before receiving the back (or forward) command is the first (or the last) node in the history chain, the GUI will move the current node position to the last (or first) node in the history chain. The GUI displays the content of the location represented by the current node position in the history chain after the move (step S48). Steps S46 to S48 are repeated when the GUI receives additional back or forward commands from the user as the user moves along the history chain.

If the command received in step S41 is a command other than a navigation command or a back or forward command, the appropriate processing is executed (step S49).

It should be noted that the GUI can have any desired features such as panes, icons, buttons, menus, etc. It has various tools for allowing the user to input the navigation command, the back and forward command, etc., and at least one pane to display the content of interest. The navigation tool and history tool may be implemented in any suitable manner, such as icons or buttons on the GUI, pre-defined key strokes, etc. The specific design of the GUI is not important. To provide convenient operation, the GUI may be designed such that an input means, such as a back arrow icon or key, can have different meanings depending on a modifier. For example, a toggle switch can be provided such that the back arrow button either means going back one step in the history chain, or means going to the previous item in a folder. As another example, in a touch screen input device, a softer “flick” may be interpreted as a command to go to the previous item in the folder, while a harder “flick” may be interpreted as a command to go to the next node in the history chain. Many other implementations are possible.

The navigation method described in FIGS. 3 and 4 may be used to implement a system for navigating any structure of data. In particular, it may be used to improve existing GUI displays that have a history chain feature, for example, Microsoft™ Outlook™, Internet Explorer, Adobe™ Reader™, etc.

In this disclosure, the term navigation generally refers to moving to various locations with a structure of data so that the content of the location can be accessed. The locations can be of any form, such as folders in a folder structure, pages or portions of pages in a document, etc. To display the content of a particular location may have different meanings depending on the structure of data. For example, it may mean displaying a list of the folder content, displaying a preview of files in the folder, displaying the content of a page of document, etc.

It will be apparent to those skilled in the art that various modification and variations can be made in the navigation method and related apparatus of the present invention without departing from the spirit or scope of the invention. Thus, it is intended that the present invention cover modifications and variations that come within the scope of the appended claims and their equivalents.

What is claimed is:

1. A method implemented in a computer for navigating a structure of data having a plurality of locations, comprising:
(a) receiving a navigation command from a user indicating a selected location in the structure of data;
(b) displaying a content of the selected location;
(c) storing a representation of the selected locations as a node in a history chain;
(d) repeating steps (a) to (c) to build the history chain, the history chain having a sequence of nodes including a first node and a last node, each node representing a selected location received in step (a);
(e) receiving a back command or a forward command from the user;
(f) moving a current node position in the history chain backward or forward by one node in response to receiving the back command or forward command, respectively, wherein when the current node position is the first node, the current node position is moved to the last node in response to receiving the back command, and when the current node position is the last node, the current location is moved to the first node in response to receiving the forward command;
(g) displaying a content of the location represented by the current node position in the history chain; and
(h) repeating steps (e) to (g).

2. The method of claim 1, wherein the navigation commands are received via a navigation tool of a graphical user interface (GUI), and the back command and the forward command are received via a history tool of the GUI.

3. The method of claim 1, wherein the structure of data is a folder tree having multiple folders and each location is a folder.

4. The method of claim 1, wherein the structure of data is a document having multiple pages and each location is a page or portion of a page.

5. A computer program product comprising a computer usable non-transitory medium having a computer readable program code embedded therein for controlling a computer, the computer readable program code configured to cause the computer to execute a process for navigating a structure of data having a plurality of locations, the process comprising:
(a) receiving a navigation command from a user indicating a selected location in the structure of data;
(b) displaying a content of the selected location;
(c) storing a representation of the selected locations as a node in a history chain;
(d) repeating steps (a) to (c) to build the history chain, the history chain having a sequence of nodes including a first node and a last node, each node representing a selected location received in step (a);
(e) receiving a back command or a forward command from the user;
(f) moving a current node position in the history chain backward or forward by one node in response to receiving the back command or forward command, respectively, wherein when the current node position is the first node, the current node position is moved to the last node in response to receiving the back command, and when the current node position is the last node, the current location is moved to the first node in response to receiving the forward command;
(g) displaying a content of the location represented by the current node position in the history chain; and
(h) repeating steps (e) to (g).

6. The computer program product of claim 5, wherein the navigation commands are received via a navigation tool of a graphical user interface (GUI), and the back command and the forward command are received via a history tool of the GUI.

7. The computer program product of claim 5, wherein the structure of data is a folder tree having multiple folders and each location is a folder.

8. The computer program product of claim 5, wherein the structure of data is a document having multiple pages and each location is a page or portion of a page.
